(19) United States
(12) Patent Application Publication
(10) Pub. No.: US 2007/0163380 A1
(43) Pub. Date: Jul. 19, 2007

(54) Bicycle pedal with converging treading surfaces

(76) Inventor: Min-Chang Chen, Taichung Hsien (TW)

Correspondence Address: HARNESS, DICKEY & PIERCE, P.L.C., P.O. BOX 8910, RESTON, VA, 20195, US

(21) Appl. No.: 11/258,054

(22) Filed: Oct. 26, 2005

(51) Int. Cl. G05G 1/14

(52) U.S. Cl. 74/594.4; 74/594.6

(57) ABSTRACT

A bicycle pedal is adapted to be rotatably mounted on a pedal shaft of a bicycle about an axis, and includes a tread having upper and lower treading surfaces disposed respectively at two opposite sides of the axis. The upper and lower treading surfaces converge along the axis such that a first thickness defined between first surface ends of the upper and lower treading surfaces is larger than a second thickness defined between second surface ends of the upper and lower treading surfaces, thereby enabling the rider to rest the inside and outside portions of a foot on one of the upper and lower treading surfaces for stead and smooth pedaling of the bicycle.

### BACKGROUND OF THE INVENTION

1. Field of the Invention

This invention relates to a bicycle pedal, more particularly to a bicycle pedal which has upper and lower treading surfaces converging to an axis for facilitating treading by a rider.

2. Description of the Related Art

A conventional bicycle pedal is rotatably mounted on a pedal shaft of a bicycle about an axis, and has upper and lower treading surfaces disposed at two opposite sides of the axis and parallel to the axis for treading by a rider. When standing on the ground, most people do not have their soles completely resting on the ground. Some people also have the tendency to roll their feet inward or even outward when standing. Hence, when the rider pushes the conventional bicycle pedal to a lower dead point during cycling, the rider normally turns his feet inward so as to have the arch pressing against one of the treading surfaces for better control of the pedaling action. Thus, the rider has to bend his knees inward frequently, which causes discomfort to the rider and soreness of the legs.

### SUMMARY OF THE INVENTION

The object of the present invention is to provide a bicycle pedal which permits the rider's foot to rest steadily and comfortably thereon during pedaling.

According to this invention, the bicycle pedal is adapted to be rotatably mounted on a pedal shaft of a bicycle about an axis, and includes a tread having upper and lower treading surfaces which are opposite to each other in a transverse direction transverse to the axis and which are disposed respectively at two opposite sides of the axis for pedaling by a rider. The upper and lower treading surfaces converge along the axis such that each of the upper and lower treading surfaces has first and second surface ends opposite to each other in a longitudinal direction parallel to the axis. The tread has a first thickness that is defined between the first surface ends of the upper and lower treading surfaces, and a second thickness that is defined between the second surface ends of the upper and lower treading surfaces and that is smaller than the first thickness. Thus, inside and outside portions of the rider's foot can be rested on one of the upper and lower treading surfaces to steadily and smoothly pedal the bicycle.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic side view of the first preferred embodiment of a bicycle pedal according to this invention;

FIG. 2 is a schematic side view of the first preferred embodiment of the bicycle pedal when incorporated in a bicycle crankset;

FIG. 3 is a schematic side view similar to FIG. 2, illustrating the first preferred embodiment in another mode of use;

FIG. 4 is a schematic side view of the second preferred embodiment of a bicycle pedal according to this invention when incorporated in a bicycle crankset;

FIG. 5 is a schematic side view of the third preferred embodiment of a bicycle pedal according to this invention;

FIG. 6 is a schematic side view of the fourth preferred embodiment of a bicycle pedal according to this invention; and

FIG. 7 is a schematic top view of the fourth preferred embodiment of the bicycle pedal.

### DETAILED DESCRIPTION OF THE PREFERRED EMBODIMENTS

Before the present invention is described in greater detail, it should be noted that same reference numerals have been used to denote like elements throughout the specification.

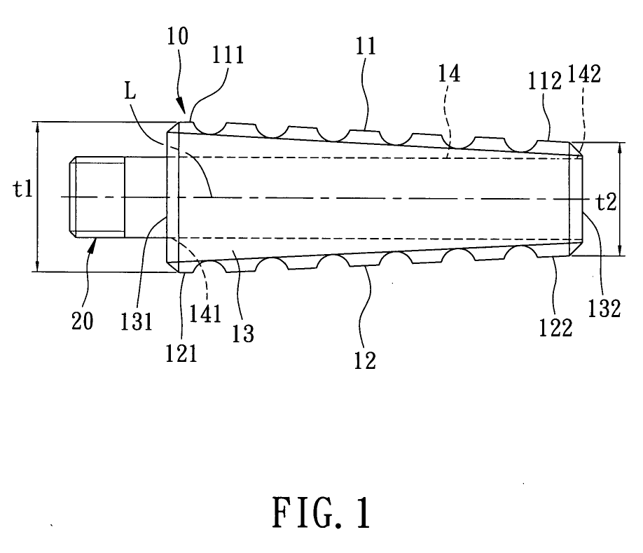

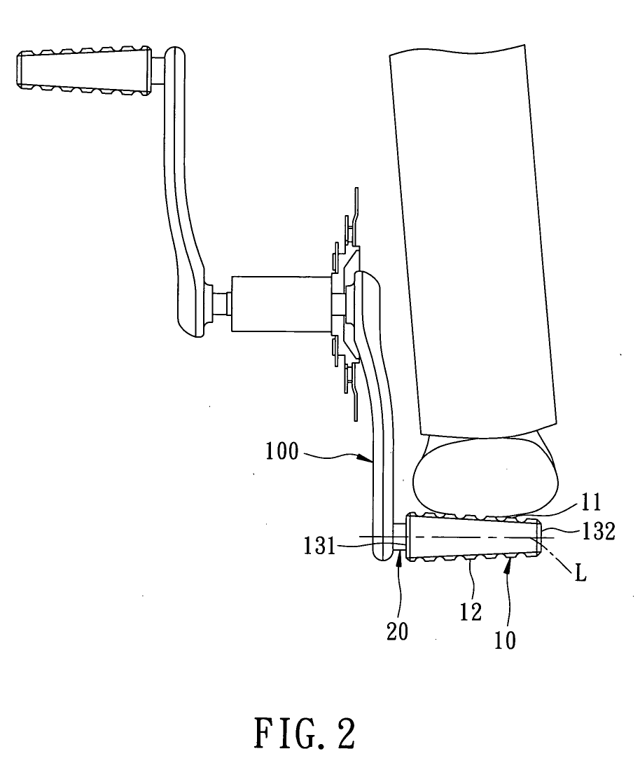

Referring to FIGS. 1 and 2, the first preferred embodiment of a bicycle pedal according to the present invention is shown to comprise a tread 10 of an integrally formed single-piece construction. The tread 10 is adapted to be rotatably mounted on a pedal shaft 20 that extends along an axis (L) and that is in turn mounted on a crankset 100 of a bicycle (not shown).

The tread 10 has upper and lower treading surfaces 11, 12 which are opposite to each other in a transverse direction transverse to the axis (L) and which are disposed respectively at two opposite sides of the axis (L) for pedaling by a rider, and a surrounding wall 13 which surrounds a centerline in the transverse direction and which interconnects peripheries of the upper and lower treading surfaces 11, 12. Each of the upper and lower treading surfaces 11, 12 has first and second surface ends 111, 121 and 112, 122 opposite to each other in a longitudinal direction parallel to the axis (L). The surrounding wall 13 has first and second wall portions 131, 132 proximate to the first surface ends 111, 121 and the second surface ends 112, 122, respectively. An axial hole 14 is formed in the tread 10, and extends along the axis (L) from the first wall portion 131 through the second wall portion 132 to form first and second open ends 141, 142 that are adapted to be sleeved on the pedal shaft 20.

The upper and lower treading surfaces 11, 12 are symmetrical to each other relative to the axis (L), and are converged along the axis (L). Specifically, the tread 10 has a first thickness (t1) that is defined between the first surface ends 111, 121 of the upper and lower treading surfaces 11, 12, and a second thickness (t2) that is defined between the second ends 112, 122 of the upper and lower treading surfaces 11, 12 and that is smaller than the first thickness (t1). In this embodiment, each of the upper and lower treading surfaces 11, 12 is inclined gradually relative to the axis (L2) from the first surface end 111, 121 to the second surface end 112, 122.

Referring again to FIG. 2, the bicycle pedal of this embodiment, which is mounted on the pedal shaft 20 in the manner as shown, is suitable for a rider whose foot is turned slightly inward during pedaling. To be specific, the first surface ends 111, 121, which have a larger distance (t1) therebetween, are disposed in proximity of the crankset 100 for the rider to rest an inside portion of the foot thereon, and the second surface ends 112, 122, which have a smaller distance (t2) therebetween, are disposed distal from the crankset 100 for the rider to rest an outside portion of the foot thereon. Thus, the inside and outside portions of the rider's foot can be rested on one of the upper and lower treading surfaces 11, 12 during pedaling to steadily and smoothly pedal the bicycle. The rider is not required to bend his knee when the bicycle pedal is pushed to a lower dead point during pedaling, thereby eliminating the aforesaid drawbacks associated with the prior art.

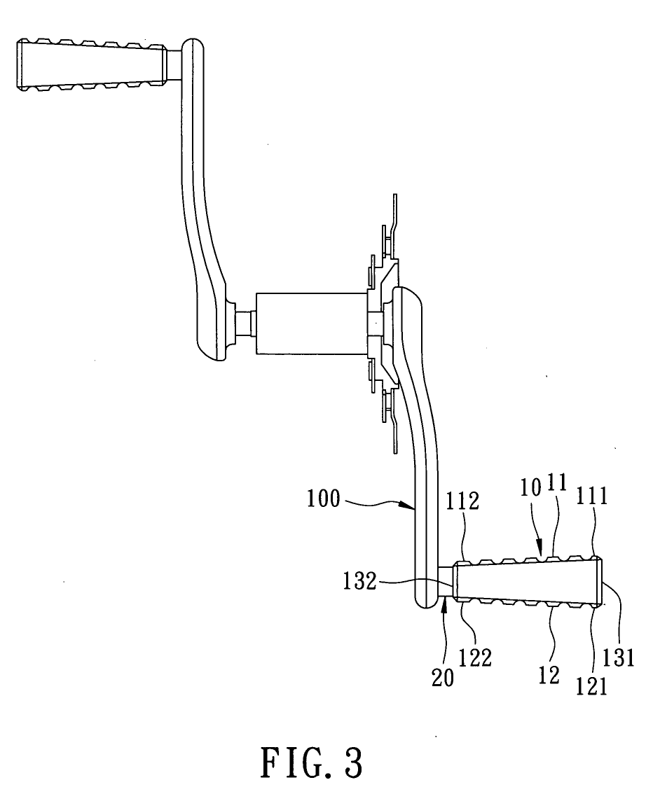

Referring to FIG. 3, when the bicycle pedal is to be used by a rider whose foot is turned slightly outward, the bicycle pedal of this invention is mounted on the pedal shaft 20 such that the second surface ends 112, 122, which have a smaller distance (t2) therebetween, are disposed in proximity of the crankset 100 for the rider to rest an inside portion of the foot thereon, and the first surface ends 111, 121, which have a larger distance (t1) therebetween, are disposed distal from the crankset 100 for the rider to rest an outside portion of the foot thereon. Thus, the rider can virtually press against the upper or lower treading surface 11, 12 for stead and smooth pedaling.

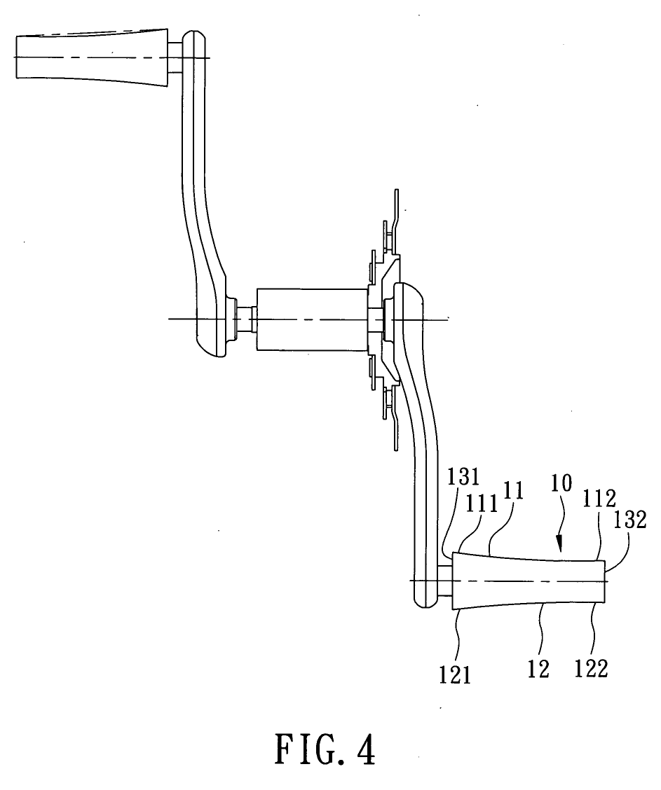

Referring to FIG. 4, the second preferred embodiment of a bicycle pedal according to this invention is shown to be similar to the first preferred embodiment. In this embodiment, each of the upper and lower treading surfaces 11, 12 of the tread 10 is formed to be recessed from the first surface end 111, 121 to the second surface end 112, 122. The tread 10 of this embodiment is also suitable for riders whose feet are turned inward and outward.

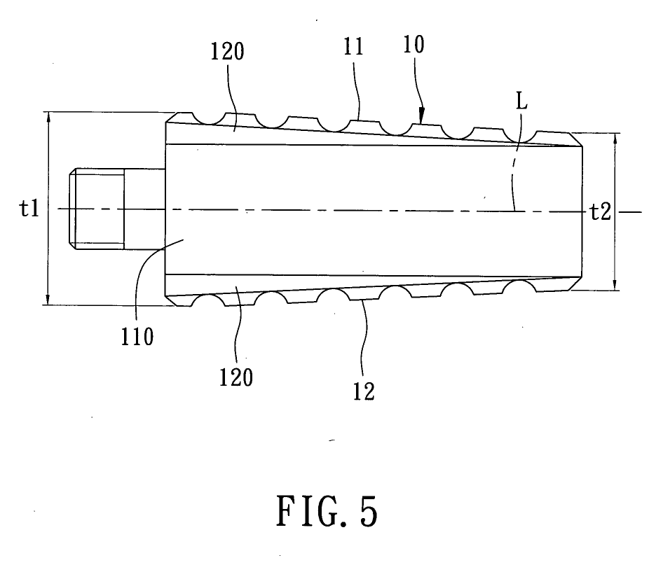

FIG. 5 shows the third preferred embodiment of a bicycle pedal according to this invention, in which the tread 10 includes a rectangular member 110 that has a centerline coincident with the axis (L), and upper and lower trihedral members 120, each of which has a base face attached to the rectangular member 110, and a slope surface that serves as a respective one of the upper and lower treading surfaces 11, 12.

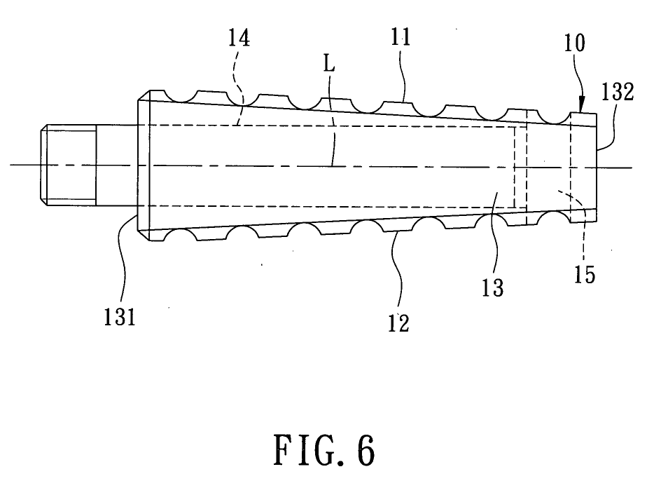

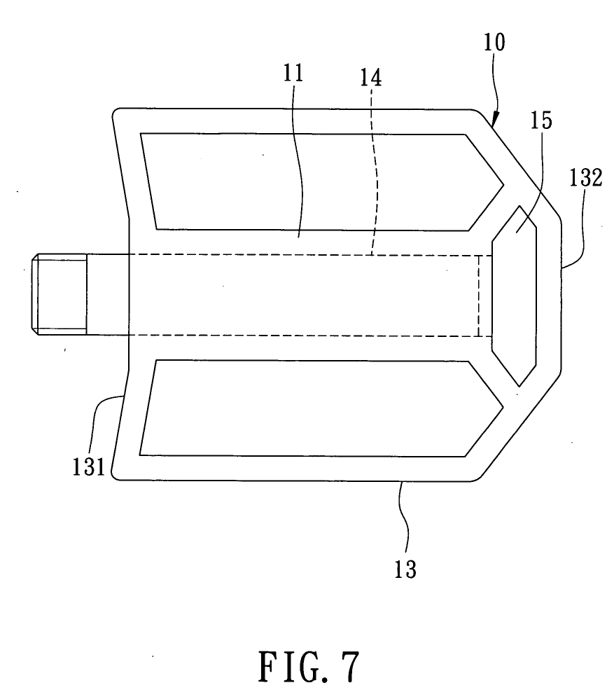

Referring to FIGS. 6 and 7, the fourth preferred embodiment of a bicycle pedal according to this invention is shown to be similar to the first preferred embodiment. In this embodiment, a slot 15 is formed proximate to the second wall portion 132 of the surrounding wall 13, and extends from the upper treading surface 11 through the lower treading surface 12. The axial hole 14 extends from the first wall portion 131 along the axis (L) to be communicated with the slot 15.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A bicycle pedal adapted to be rotatably mounted on a pedal shaft of a bicycle about an axis, comprising:
a tread having upper and lower treading surfaces which are opposite to each other in a transverse direction transverse to the axis, and which are disposed respectively at two opposite sides of the axis for pedaling by a rider, said upper and lower treading surfaces converging along the axis.

2. The bicycle pedal of claim 1, wherein each of said upper and lower treading surfaces has first and second surface ends opposite to each other in a longitudinal direction parallel to the axis such that said tread has a first thickness that is defined between said first surface ends of said upper and lower treading surfaces, and a second thickness that is defined between said second surface ends of said upper and lower treading surfaces and that is smaller than the first thickness.

3. The bicycle pedal of claim 2, wherein each of said upper and lower treading surfaces is inclined gradually relative to the axis from said first surface end to said second surface end.

4. The bicycle pedal of claim 1, wherein said upper and lower treading surfaces are symmetrical to each other relative to the axis.

5. The bicycle pedal of claim 1, wherein said tread further has a surrounding wall which surrounds a centerline in the transverse direction and which interconnects peripheries of said upper and lower treading surfaces, and an axial hole which extends along the axis through said surrounding wall to form first and second open ends that are adapted to be sleeved on the pedal shaft.

6. The bicycle pedal of claim 1, wherein said tread is of an integrally formed single-piece construction.

7. The bicycle pedal of claim 1, wherein said tread includes a rectangular member which has a centerline coincident with the axis, and upper and lower trihedral members, each of which has a base face attached to said rectangular member and a slope surface that serves as a respective one of said upper and lower treading surfaces.
